(19) United States
(12) Patent Application Publication
(10) Pub. No.: US 2017/0199730 A1
(43) Pub. Date: Jul. 13, 2017

(54) Application Modification

(71) Applicant: International Business Machines Corporation, Armonk, NY (US)

(72) Inventors: Roee Hay, Haifa (IL); Omer Tripp, Bronx, NY (US)

(21) Appl. No.: 14/992,252

(22) Filed: Jan. 11, 2016

(51) Int. Cl. G06F 9/45; G06F 17/30

(52) U.S. Cl. CPC G06F 8/433; G06F 17/30958

(57) ABSTRACT

Techniques for modifying an application are described herein. In some examples, a method includes generating, via a processor, a representation of an application and detecting a flow of data in the representation of the application based on static analysis. The method can also include detecting a predetermined property to be verified, the predetermined property comprising a source point in the representation of the application and a sink point in the representation of the application. In addition, the method can include detecting that the flow of data violates the predetermined property. Furthermore, the method can include selecting a set of changes to the representation of the application that prevents the violation of the predetermined property and modifying the application based on the selected set of changes.

### BACKGROUND

The present disclosure relates to application modification, and more specifically, but not exclusively, to modifying an application based on program verification techniques.

### SUMMARY

According to an embodiment described herein, a system for modifying an application can include a processor to generate a representation of an application and detect a flow of data in the representation of the application based on static analysis. The processor can also detect a predetermined property to be verified, the predetermined property comprising a source point in the representation of the application and a sink point in the representation of the application. The processor can also detect that the flow of data violates the predetermined property and select a set of changes to the representation of the application that prevents the violation of the predetermined property. Furthermore, the processor can modify the application based on the selected set of changes.

According to another embodiment, a method for modifying an application can include generating, via a processor, a representation of an application and detecting, via the processor, a flow of data in the representation of the application based on static analysis. The method can also include detecting, via the processor, a predetermined property to be verified, the predetermined property comprising a source point in the representation of the application and a sink point in the representation of the application. Furthermore, the method can include detecting, via the processor, that the flow of data violates the predetermined property and selecting, via the processor, a set of changes to the representation of the application that prevents the violation of the predetermined property. Additionally, the method can include modifying, via the processor, the application based on the selected set of changes.

According to another embodiment, a computer program product for modifying an application can include a computer readable storage medium having program instructions embodied therewith, wherein the computer readable storage medium is not a transitory signal per se. The program instructions can be executable by a processor to cause the processor to generate, via the processor, a representation of an application and detect a flow of data in the representation of the application based on static analysis. The program instruction can also be executable by the processor to cause the processor to detect a predetermined property to be verified, the predetermined property comprising a source point in the representation of the application and a sink point in the representation of the application. Furthermore, the program instructions can also be executable by the processor to cause the processor to detect that the flow of data violates the predetermined property, select a set of changes to the representation of the application that prevents the violation of the predetermined property, and modify the application based on the selected set of changes.

### BRIEF DESCRIPTION OF THE SEVERAL VIEWS OF THE DRAWINGS

FIG. 1 depicts a block diagram of an example computing system that can modify an application according to an embodiment described herein;

FIG. 2 is a process flow diagram of an example method that can modify an application according to an embodiment described herein;

FIG. 3 is an example illustration of a representation of an application; and

FIG. 4 is a tangible, non-transitory computer-readable medium that can modify an application according to an embodiment described herein.

### DETAILED DESCRIPTION

Software applications continue to grow in complexity, which results in applications with additional functions and additional function calls. Accordingly, verifying that an application exhibits a certain predetermined behavior can be increasingly time consuming. In some examples, applications can be executed with a large number of input values and the applications can be dynamically verified based on the results of the execution of the application for each value. For example, each execution of an application with a value can indicate if a predetermined condition or behavior is violated. However, this approach can be impractical if there are too many paths for data to flow in an application.

The embodiments described herein include techniques for verifying an application does not exhibit a predetermined behavior or property and modifying the application if the predetermined behavior or property exists. In some embodiments, the techniques include generating a representation of an application and detecting a predetermined property to be verified for the application. The representation of the application can be any suitable abstract data type such as a call graph, interprocedural graph, and the like. The representation can indicate the flow of data through an application by indicating a relationship between any number of functions or methods within the application. The predetermined property can include any suitable security preference, and the like that can indicate a restriction or condition associated with data flow in an application. For example, the predetermined property can indicate that data should not flow between two functions in an application to prevent a potential security issue.

The techniques described herein can verify that an application does not include violations of a predetermined property or an application can be modified to remove a violation of a predetermined property if a violation is detected. In some embodiments, an application can be modified to remove a function call or remove any number of instructions from the application. The modified application can prevent security issues such as preventing malicious code inserted via user input from accessing a sensitive function or method of an application. A sensitive function, as referred to herein, can include any function that accesses confidential information or information that requires authorization to view and or retrieve.

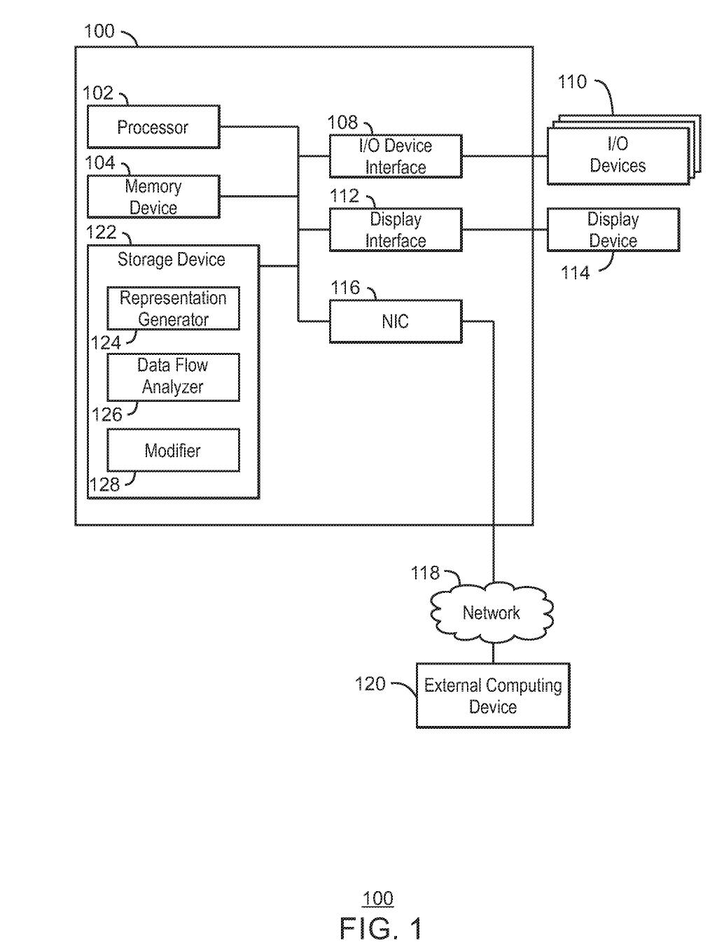

With reference now to FIG. 1, an example computing device is depicted that can modify an application. The computing device 100 may be for example, a server, desktop computer, laptop computer, tablet computer, or smartphone. In some examples, computing device 100 may be a cloud computing node. Computing device 100 may be described in the general context of computer system executable instructions, such as program modules, being executed by a computer system. Generally, program modules may include routines, programs, objects, components, logic, data structures, and so on that perform particular tasks or implement particular abstract data types. Computing device 100 may be practiced in distributed cloud computing environments where tasks are performed by remote processing devices that are linked through a communications network. In a distributed cloud computing environment, program modules may be located in both local and remote computer system storage media including memory storage devices.

The computing device 100 may include a processor 102 that is adapted to execute stored instructions, a memory device 104 to provide temporary memory space for operations of said instructions during operation. The processor can be a single-core processor, multi-core processor, computing cluster, or any number of other configurations. The memory 104 can include random access memory (RAM), read only memory, flash memory, or any other suitable memory systems.

The processor 102 may be connected through a system interconnect 106 (e.g., PCI®, PCI-Express®, etc.) to an input/output (I/O) device interface 108 adapted to connect the computing device 100 to one or more I/O devices 110. The I/O devices 110 may include, for example, a keyboard and a pointing device, wherein the pointing device may include a touchpad or a touchscreen, among others. The I/O devices 110 may be built-in components of the computing device 100, or may be devices that are externally connected to the computing device 100.

The processor 102 may also be linked through the system interconnect 106 to a display interface 112 adapted to connect the computing device 100 to a display device 114. The display device 114 may include a display screen that is a built-in component of the computing device 100. The display device 114 may also include a computer monitor, television, or projector, among others, that is externally connected to the computing device 100. In addition, a network interface controller (NIC) 116 may be adapted to connect the computing device 100 through the system interconnect 106 to the network 118. In some embodiments, the NIC 116 can transmit data using any suitable interface or protocol, such as the internet small computer system interface, among others. The network 118 may be a cellular network, a radio network, a wide area network (WAN), a local area network (LAN), or the Internet, among others. An external computing device 120 may connect to the computing device 100 through the network 118. In some examples, external computing device 120 may be an external webserver 120. In some examples, external computing device 120 may be a cloud computing node.

The processor 102 may also be linked through the system interconnect 106 to a storage device 122 that can include a hard drive, an optical drive, a USB flash drive, an array of drives, or any combinations thereof. In some examples, the storage device may include a representation generator 124, a data flow analyzer 126, and a modifier 128. The representation generator 124 can detect any suitable application and generate a representation of the application. The application can include a mobile application, an enterprise application, or any other suitable computer program. The representation, as discussed above, can be any suitable abstract data type that indicates a flow of data within an application. For example, the representation of an application can be a call graph or interprocedural graph that indicates a flow of data in an application based on function calls. Each call graph can include an edge that represents a function call from a first function to a second function.

In some embodiments, the data flow analyzer 126 can detect a predetermined property to be verified. The predetermined property can include any suitable type state, security preference, or privacy preference that is to be verified within an application. In some embodiments, the predetermined property includes a source point in the representation of the application and a sink point in the representation of the application. The source point can correspond to a beginning point in a program to be verified and the sink point can correspond to an end point in a program to be verified. In some examples, the predetermined property can indicate that the data flow in the application cannot include a path between the source point and the sink point to prevent security and privacy vulnerabilities. In some embodiments, the data flow analyzer 126 can also detect that the flow of data violates a predetermined property.

In some embodiments, the modifier 128 can detect a set of changes to the representation of the application that prevents the violation of the predetermined property and modify the application based on the set of changes. For example, the modifier 128 can remove function calls and instructions within an application to prevent a flow of data between a source point and a sink point that violates a predetermined property.

It is to be understood that the block diagram of FIG. 1 is not intended to indicate that the computing device 100 is to include all of the components shown in FIG. 1. Rather, the computing device 100 can include fewer or additional components not illustrated in FIG. 1 (e.g., additional memory components, embedded controllers, modules, additional network interfaces, etc.). Furthermore, any of the functionalities of the representation generator 124, data flow analyzer 126, and modifier 128 may be partially, or entirely, implemented in hardware and/or in the processor 102. For example, the functionality may be implemented with an application specific integrated circuit, logic implemented in an embedded controller, or in logic implemented in the processor 102, among others. In some embodiments, the functionalities of the representation generator 124, data flow analyzer 126, and modifier 128, can be implemented with logic, wherein the logic, as referred to herein, can include any suitable hardware (e.g., a processor, among others), software (e.g., an application, among others), firmware, or any suitable combination of hardware, software, and firmware.

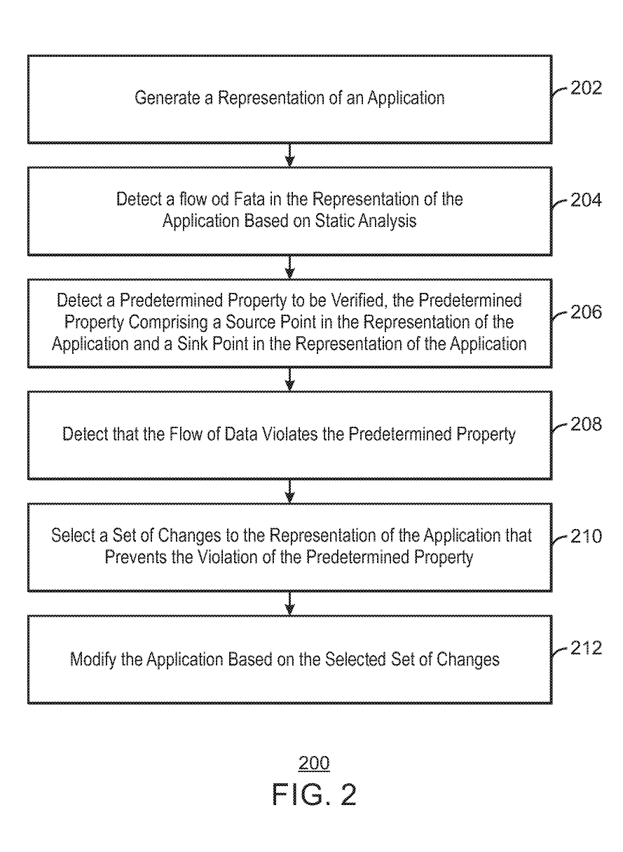

FIG. 2 is a process flow diagram of an example method that can modify an application. The method 200 can be implemented with any suitable computing device, such as the computing device 100 of FIG. 1.

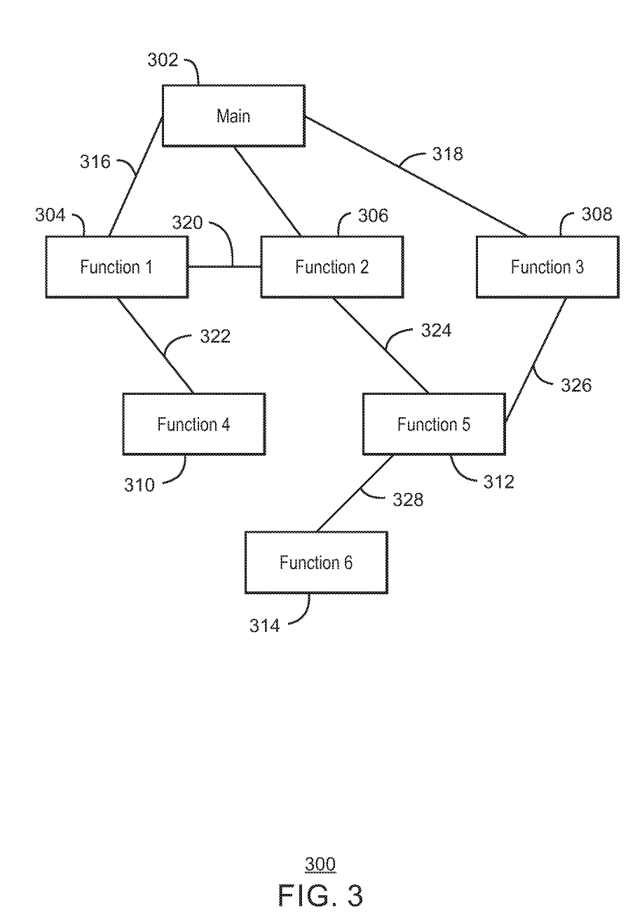

At block 202, a representation generator 124 can generate a representation of an application. As discussed above, the representation can include any suitable abstract data type that indicates a flow of data between functions in an application. An example representation of a call graph is described below in relation to FIG. 3.

At block 204, the data flow analyzer 126 can detect a flow of data in the representation of the application based on static analysis. For example, the static analysis can include data slicing or taint analysis. Data slicing, as referred to herein, can identify and extract interdependent instructions. For example, data slicing can enable the identification and extraction of instructions that share common variables or any other information that is interdependent. Taint analysis, as referred to herein, can include detecting variables corresponding to user input and identifying any instructions or expressions that include these variables. The taint analysis enables the identification of instructions that are exposed to user input and therefore may include a security vulnerability. The data flow analyzer 126 can use the static analysis to identify a flow of data within an application and identify any instructions that may include a security vulnerability. In some embodiments, the static analysis is based on the representation of the application. For example, the static analysis can be based on a call graph or interprocedural representation of an application.

At block 206, the data flow analyzer 126 can detect a predetermined property to be verified, wherein the predetermined property comprises a source point in the representation of the application and a sink point in the representation of the application. In some embodiments, the source point can be identified based on the static analysis of the application. For example, the source point can include an instruction which sets a value of a variable equal to user input. The sink point can indicate an instruction or function in the application that accesses authorized data and should not be accessible from the source point. For example, the source point may enable user input that includes scripting characters, or other malicious code, that can enable an unauthorized user to retrieve sensitive or confidential information from the sink point. In some embodiments, the predetermined property can indicate any suitable data type, security state, or privacy state that an application is to enforce.

At block 208, the data flow analyzer 126 can detect that the flow of data violates the predetermined property. For example, the data flow analyzer 126 can detect that an application includes a path of data flow between a source point and a sink point. As discussed above, the path of data flow between the source point and sink point can indicate a security vulnerability in the application that allows an unauthorized user to access confidential information.

At block 210, the modifier 128 can select a set of changes to the representation of the application that prevents the violation of the predetermined property. The set of changes can include removing edges from a call graph or any other suitable technique to indicate that a function call from a first function to a second function is to be blocked or removed from the application. In some embodiments, any number of function calls can be removed to prevent the flow of data from a source point to a sink point. The set of changes can be selected from a list of potentials sets of changes. For example, the list can include multiple sets of changes that each prevent a violation of the predetermined property. The modifier 128 can select a set of changes from the list that prevents the violation of the predetermined property with a lowest number of modifications or changes to the representation of the application.

In some examples, the modifier 128 can identify the set of changes to the representation of the application with an iterative technique. For example, the modifier 128 can detect a first set of changes, apply the first set of changes to a representation of the application, and determine that the first set of changes do not prevent the violation of the predetermined property. In some embodiments, the modifier 128 can repeat these steps any number of times in order to determine a set of changes to a representation of an application that prevents data flow between a source point and a sink point. For example, the modifier 128 can detect a second set of changes, apply the second set of changes to the representation of the application, and detect that the second set of changes prevent the violated to the predetermined property.

At block 212, the modifier 128 can modify the application based on the set of changes. For example, the modifier 128 can detect the set of changes to the representation that prevent a violation of a predetermined property and the modifier can implement the set of changes to the source code of the application. For example, the modifier 128 can remove a function call to prevent a flow of data between a source point and a sink point. The modifier 128 can also modify a type of a data structure in the application and the like.

The process flow diagram of FIG. 2 is not intended to indicate that the operations of the method 200 are to be executed in any particular order, or that all of the operations of the method 200 are to be included in every case. Additionally, the method 200 can include any suitable number of additional operations. For example, the modifier 128 can also generate a set of warnings based on a comparison of the application and the modified application. The set of warnings can indicate a break line between the source point and the sink point. A break line, as referred to herein, indicates a first function no longer includes a function call to a second function. For example, the set of warnings can indicate that data no longer flows between a source point and a sink point of an application because of a break line in the representation of an application.

FIG. 3 is an example illustration of a representation of an application. The representation of the application can be generated with any suitable computing device such as computing device 100 of FIG. 1.

In some embodiments, a representation of an application 300 can include any number of nodes and edges. Each node 302, 304, 306, 308, 310, 312, and 314 can each correspond to a function in the application such as a main function 302 and functions 1-6 304-314. Each node can be connected by an edge 316, 318, 320, 322, 324, 326, or 328, wherein each edge represents a function call. Any node can be identified as a source point. For example, a node that receives user input may be identified as a source point. A sink point can be any node that accesses authorized or confidential information. For example, the sink point can include an instruction that stores data in a database, retrieves data from a database, or accesses confidential information stored in any suitable location. The representation 300 of the application can be modified by removing edges between a source point and a sink point to prevent a security vulnerability. For example, an edge can be removed to prevent malicious code inserted into the application at the source point from accessing authorized data at the sink point.

In one example, function 6 314 of FIG. 3 can access confidential information. Therefore, function 6 314 can be identified as a sink point in the application. Function 1 304 can include an instruction requesting user input. Therefore, function 1 304 can be identified as a source point in some examples. Based on the representation of the application in FIG. 3, the data flow analyzer 126 can determine that a path of data flow exists between function 1 304 and function 6 314 via edge 320, function 2 306, edge 324, function 5 312, and edge 328. Therefore, the representation 300 of the application indicates a violation of a predetermined property because data flows from the source point to the sink point. Accordingly, the modifier 128 can remove edge 320 to prevent a flow of data between function 1 304 and function 2 306. The modifier 128 can then modify the source code of the application to remove the corresponding function call from function 1 304 to function 2 306. The modified application can result in function 2 306, function 3 308, and function 5 312 accessing the sink point of function 6 314. However, in the modified application, function 1 304 can access function 4 310 and the main function 302.

It is to be understood that the representation of the application in FIG. 3 is only an example. The representation of the application can be modified in any suitable number of ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

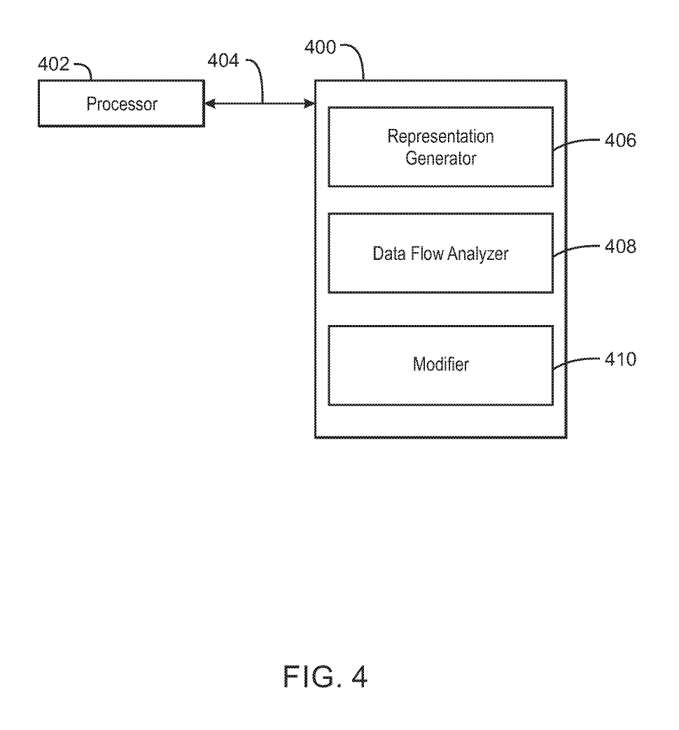

Referring now to FIG. 4, a block diagram is depicted of an example of a tangible, non-transitory computer-readable medium that can modify an application. The tangible, non-transitory, computer-readable medium 400 may be accessed by a processor 402 over a computer interconnect 404. Furthermore, the tangible, non-transitory, computer-readable medium 400 may include code to direct the processor 402 to perform the operations of the current method.

The various software components discussed herein may be stored on the tangible, non-transitory, computer-readable medium 400, as indicated in FIG. 4. For example, a representation generator 406 can generate a representation of an application. A data flow analyzer 408 can detect a flow of data in the representation of the application based on static analysis and detect a predetermined property to be verified, the predetermined property comprising a source point in the representation of the application and a sink point in the representation of the application. The data flow analyzer 408 can also detect that the flow of data violates the predetermined property. The modifier 410 can detect a set of changes to the representation of the application that prevents the violation of the predetermined property and modify the application based on the set of changes.

It is to be understood that any number of additional software components not shown in FIG. 4 may be included within the tangible, non-transitory, computer-readable medium 400, depending on the specific application. Furthermore, fewer software components than those shown in FIG. 4 can be included in the tangible, non-transitory, computer-readable medium 400.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A system for modifying an application comprising:
a processor, programmed with instructions, to:
generate a representation of an application;
detect a flow of data in the representation of the application based on static analysis;
detect a predetermined property to be verified, the predetermined property comprising a source point in the representation of the application and a sink point in the representation of the application;
detect that the flow of data violates the predetermined property;
select a set of changes to the representation of the application that prevents the violation of the predetermined property, the set of changes to the representation of the application being selected from a plurality of sets of changes to the representation of the application based upon the set of changes that prevents violation of the predetermined property with a lowest number of modifications to the representation of the application; and
modify the application based on the selected set of changes.

2. The system of claim 1, wherein the representation of the application is an interprocedural call graph.

3. The system of claim 1, wherein the static analysis comprises data slicing.

4. The system of claim 1, wherein the static analysis comprises taint analysis.

5. The system of claim 1, wherein the processor is to select the set of changes from a list of potential sets of changes that prevent the violation of the predetermined property.

6. The system of claim 1, wherein the processor is to generate a set of warnings based on a comparison of the application and the modified application.

7. The system of claim 6, wherein the set of warnings indicate a break line between the source point and the sink point.

8. The system of claim 1, wherein the modification to the application comprises removing a function call to prevent the flow of data from reaching the sink point.

9. (canceled)

10. A method for modifying an application comprising:
generating, via a processor, a representation of an application;
detecting, via the processor, a flow of data in the representation of the application based on static analysis;
detecting, via the processor, a predetermined property to be verified, the predetermined property comprising a source point in the representation of the application and a sink point in the representation of the application;
detecting, via the processor, that the flow of data violates the predetermined property;
selecting, via the processor, a set of changes to the representation of the application that prevents the violation of the predetermined property, the set of changes to the representation of the application being selected from a plurality of sets of changes to the representation of the application based upon the set of changes that prevents violation of the predetermined property with a lowest number of modifications to the representation of the application; and
modifying, via the processor, the application based on the selected set of changes.

11. The method of claim 10, wherein the representation of the application is an interprocedural call graph.

12. The method of claim 10, wherein the static analysis comprises data slicing.

13. The method of claim 10, wherein the static analysis comprises taint analysis.

14. (canceled)

15. The method of claim 10, comprising generating a set of warnings based on a comparison of the application and the modified application.

16. The method of claim 15, wherein the set of warnings indicate a break line between the source point and the sink point.

17. A computer program product for modifying an application, the computer program product comprising a computer readable storage medium having program instructions embodied therewith, wherein the computer readable storage medium is not a transitory signal per se, the program instructions executable by a processor to cause the processor to:
generate, via the processor, a representation of an application;
detect, via the processor, a flow of data in the representation of the application based on static analysis;
detect, via the processor, a predetermined property to be verified, the predetermined property comprising a source point in the representation of the application and a sink point in the representation of the application;
detect, via the processor, that the flow of data violates the predetermined property;
select, via the processor, a set of changes to the representation of the application that prevents the violation of the predetermined property, the set of changes to the representation of the application being selected from a plurality of sets of changes to the representation of the application based upon the set of changes that prevents violation of the predetermined property with a lowest number of modifications to the representation of the application; and
modify, via the processor, the application based on the selected set of changes.

18. The computer program product of claim 17, wherein the representation of the application is an interprocedural call graph.

19. The computer program product of claim 17, wherein the static analysis comprises data slicing.

20. The computer program product of claim 17, wherein the static analysis comprises taint analysis.
